(19) United States
(12) Patent Application Publication
(10) Pub. No.: US 2004/0030709 A1
(43) Pub. Date: Feb. 12, 2004

(54) Personalized setup poster generation

(75) Inventor: Kim C. Smith, Dove Canyon, CA (US)

Correspondence Address: GATEWAY, INC., ATTN: SCOTT CHARLES RICHARDSON, 610 GATEWAY DR., Y-04, N. SIOUX CITY, SD, 57049, US

(73) Assignee: Gateway, Inc.

(21) Appl. No.: 10/141,721

(22) Filed: Aug. 12, 2002

(51) Int. Cl. G06F 17/00

(52) U.S. Cl. 707/102

(57) ABSTRACT

A computer implemented method generates installation instructions for multiple devices to be configured in a network environment. Information regarding devices to be coupled by a network is first obtained from a user and databases. Customized instructions for setting up the devices are then generated. Graphical representations, including images of the devices are included as part of the instructions indicating an order for setting up the devices.

### FIELD OF THE INVENTION

The present invention relates to networking devices, and in particular to generation of a personalized set of instructions for setting up multiple devices in a network.

### BACKGROUND OF THE INVENTION

Setup posters are printed materials depicting how to set up computer systems and networks of devices. They have been helpful, especially for users with less experience setting up such networks. However, such posters are both generic, and rendered obsolete by rapid changes in technology. Users find that steps to set up the network are missing, or don't apply to them. This is an added source of frustration for a user faced with an already complex task. Many users are faced with hooking up several or many devices or appliances, not all of which are part of a newly purchased package. Some of the appliances may also pre date new purchases, and the technologies involved may vary widely in sophistication.

### SUMMARY OF THE INVENTION

A computer implemented method generates installation instructions for multiple devices to be configured in a network environment. Information regarding devices to be coupled by a network is first obtained from a user. Customized instructions for setting up the devices are then generated. Graphical representations of the devices are included as part of the instructions indicating an order for setting up the devices.

In one embodiment, further databases are queried to obtain further information for customization of the instructions, such as images of the devices, network identifications and information regarding proper setup wizards to use while setting up the devices. The data collected from the user and other databases is used to create a networking file identifying the user, the devices, and recommended topology of the network, as well as personalized information.

In one embodiment, the instructions are in the form of a poster with images of devices. Further images are provided for selected devices illustrating preferred sequences of cabling and attachment of further devices. The poster also includes tips to a user for readying the installation environment such as a home for networking.

### BRIEF DESCRIPTION OF THE DRAWINGS

FIG. 1 is a flowchart of a process for creating and using a personalized setup poster for setting up a network of devices.

FIG. 2 is a flowchart showing user interaction with a device implementing the process of FIG. 1.

FIG. 3 is a representation of a sample database record for a user.

FIG. 4 is a representation of a poster generated in accordance with the present invention to assist in the setup of a network of devices.

FIG. 5 is a representation of additional instructional text and images specific to a user's setup needs.

FIG. 6 is a flowchart of a process of setting up the network using the setup poster.

FIG. 7 is block diagram of a computer system for implementing the functions of the present invention.

### DETAILED DESCRIPTION OF THE INVENTION

In the following description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

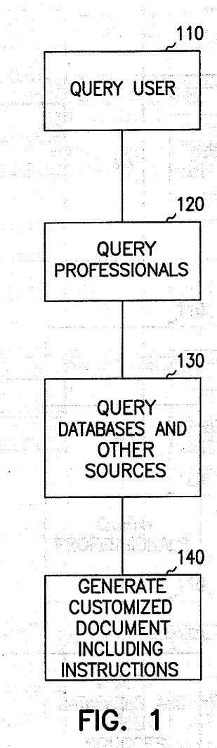

FIG. 1 is a flowchart of a process for creating and using a personalized setup poster for setting up a network of devices. A user is queried about devices that they wish to attach at 110 by use of a computer or kiosk or other electronic appliance or person using an electronic appliance to create a home networking file. This occurs in the context of the user buying a piece of equipment such as a personal computer, and desiring to connect multiple devices into a network. At 120, a person or expert system proficient in networking is optionally consulted to provide further information to aid in identifying how to connect the devices in the network. Such person or expert system is referred to as a professional. Other sources are then queried at 130 to supplement the home networking file. The other sources include databases providing further personal information about the user, including Internet service provider (ISP) information. Upon completion of the home networking file, a customized document is produced, providing instructions for assembling the network of devices.

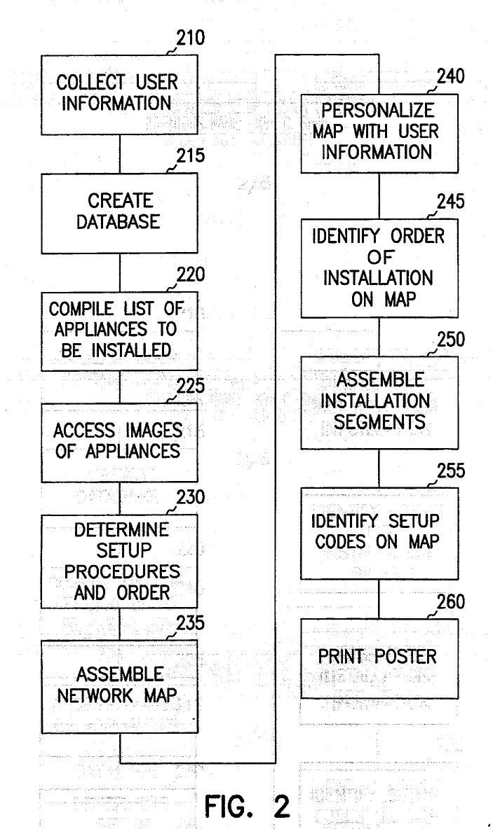

Further detail of user interaction with a device implementing the instruction generation process of FIG. 1 is shown in FIG. 2. At 210, user information is collected, such as by an interactive session with a computer system. In one embodiment, the information is entered by the user or other person into a form on a computer display. In further embodiment, the information is collected via a question and answer session. A home networking file is created at 215 in a relational database format. Other formats are used in further embodiments.

The database includes a compilation of a list of appliances to be installed as collected at 220. As above, the database includes further information about the user and outside network connections. Images for the appliances are gathered from a further database for later use in creating a poster to aid the user in assembling the network at 225.

At 230, the instruction generation process determines a network topology, such as by selecting from a number of predetermined topologies, or applying expert rules. Once the topology is determined, procedures for setting up the network, and the order in which the devices are connected is determined at 230. A network map is then assembled from the topology at 235, and images for the devices are optionally utilized in the map. At 240, the map is further personalized with information the user will need to both help identify settings of devices and data to enter while setting up the devices. The order of installation is then identified on the map at 245.

The instruction generation process also includes information regarding the assembly of segments of the network. Information in the form of text, and/or images are generated to show specific connections to be made to each of the devices at 250. Setup codes are also identified on the map at 255 to aid in the selection of the proper setup software associated with the various devices. Finally, the map and instructions are provided to the user in the form of a poster or other printed or otherwise viewable material. A poster is a document that has been customized before printing to contain information specific to a user's setup tasks. In one embodiment, the poster is in the form of a large, single sheet of paper, a booklet of several pages. It may be labeled “Quick Start” or some other indication that informs a user of the utility of the poster in setting up their system.

In a typical scenario of a user coming to a store to purchase a computer or other appliance to be added to a network, the user is guided to a display, such as a flat panel display with keyboard or other data entry device. The user sits and works through a set of interactive screens, checking boxes, entering information, asking frequently asked questions and exploring suggested options. The options are based upon answers given regarding the appliances or devices to be networked, as well as how the system will be used. The information gathered in this manner is both a first step in educating the user, and is also a great way for a sales person/professional to get better acquainted with the user's unique set of networking requirements.

Once finished at the interactive display, the user is treated to a one-on-one consultation with a sales person who is knowledgeable in home networking. As a result, still more information is added to a networking file. This includes, for instance, the user's internet service provider information which was obtained from a database. A personal poster is then generated which includes an installation plan type that, based upon the consultation, provides the closest fit to the user's unique networking requirements.

At the end of the consultation, the user heads home with a poster printed out in the store, or it arrives with the networking components ordered. The poster contains tips on ways in which the user can ready their home environment for networking. When the components arrive, the poster leads the user through the first steps of the setup. When the setup wizard is launched, the user selects the plan identified on the poster, or the wizard is factory loaded with the proper information, causing the wizard to configure itself to fit the setup needs of the user's network. At several points, the user refers back to the poster for key pieces of information to enter that are specific to the user, or such information are preprogrammed into the wizard. When finished, the poster serves as a useful map and reminder of specific settings.

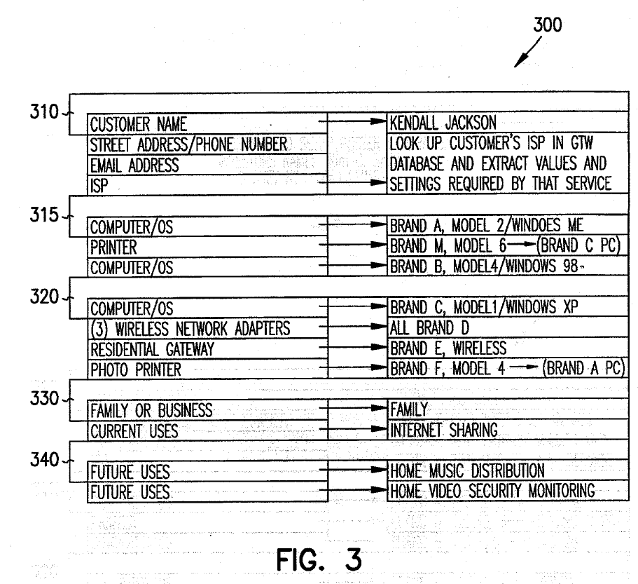

A sample database record for a user is shown in FIG. 3 generally at 300. Information obtained includes customer name and contact information, including email address and ISP at 310. At 315, a list of existing devices is collected. Such devices commonly include but are not limited to printers, scanners, digital cameras, fax machines, personal digital assistants, video cameras, external storage devices and others now known and hereafter invented. Devices being purchased are indicated at 320, such as a computer, multiple wireless network adaptors, and photo printer to name a few. Information about brand, model and version numbers of the devices and associated software is also maintained.

Utilization of the computer is indicated at 330. Utilization information includes whether the computer, device or network is being utilized in a business or family setting, and lists uses to which the computer will be put, such as games, video, photos, internet sharing, etc. Future uses are also identified at 340, and includes uses such as home music distribution, video security monitoring and other potential uses.

Information from other databases is also collected for populating the home networking file/database. As indicated above, pictures such as photos, line drawings which are specific or generic or other representations of devices is obtained from other databases, or different portions of the same database. Setup chunks with screen-shots of wizard screens running under supported operating systems are available in some embodiments. Promotional material is also available in one embodiment. Such material includes information regarding ways to exploit a home network, for example, music distribution.

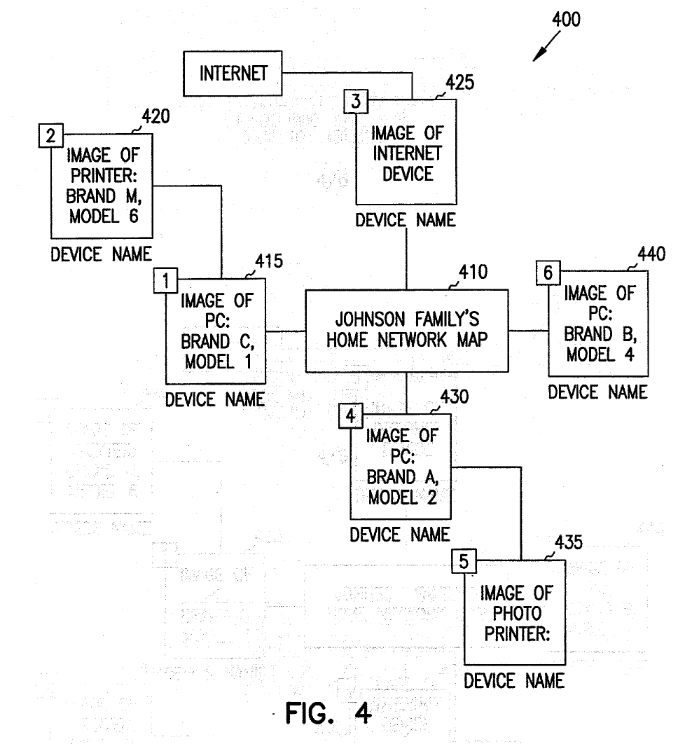

FIG. 4 is a representation of one poster generated in accordance with the present invention to assist in the setup of a network of devices. The poster, shown generally at 400, is produced in accordance with the process of FIG. 2 and utilizing the database records shown and described in FIG. 3. A network 410 is shown surrounded by a number of devices to be attached to the network in a predetermined order on the poster 400. The first device to be installed in this particular topology of devices is a personal computer 415, shown by an image of the computer. The user is reminded to follow numbers associated with each device in proper order to set up the network. The number associated with computer 415 is “1” signifying that this device should be first set up and coupled to the network. The next device, printer 420, also represented by an image, is shown as being coupled to the personal computer 415, not directly to the network. It is identified by the number “2”. Next, an Internet device 425, coupled to the internet, allows multiple devices to utilize the Internet in a home networking environment.

A second personal computer at 430 is represented by an image, and is the fourth device to be installed. A photo printer 435 is coupled to the second personal computer following its installation. Finally, a third personal computer 440 is coupled to the network and set up as the sixth device. In one embodiment a device name is provided with each of the devices, along with other personalized information.

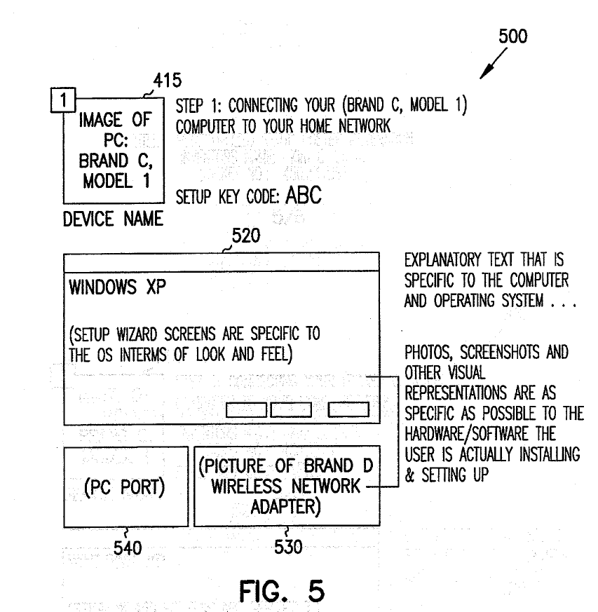

Additional instructional text and images are shown for installation of the first device, personal computer 415 in FIG. 5. A setup key code “ABC” is provided to ensure that the correct setup software procedures are executed. A screenshot 520, specific to the hardware/software that is being installed, is also provided. A picture of a wireless network adapter 530 is also provided, and shown with the personal computer port with which it is associated.

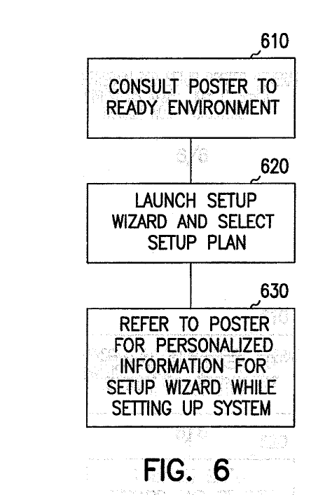

FIG. 6 is a flowchart of a user setting up devices on a network using a poster. Prior to beginning setting up the system, the poster is used to help setup the environment in which the devices will reside at 610. The environment includes the selection and placement of furniture and planning access points to the network. With the use of wireless networking adapters, access points are somewhat given, but there may still be restrictions on the location of devices based on other household appliances. Upon availability of devices, such as receiving new devices, a setup wizard is launched, and a setup plan is selected based on a plan identification code on the poster, or other materials associated with the devices at 620. At 630, the user refers to the poster for personalized information for the setup wizard while setting up the network of devices. Upon completion of the setup in accordance with the poster, the devices are ready to use. In one embodiment, the proper setup wizard is loaded into the first device to be setup based on the topology of the network and plan generated therefrom.

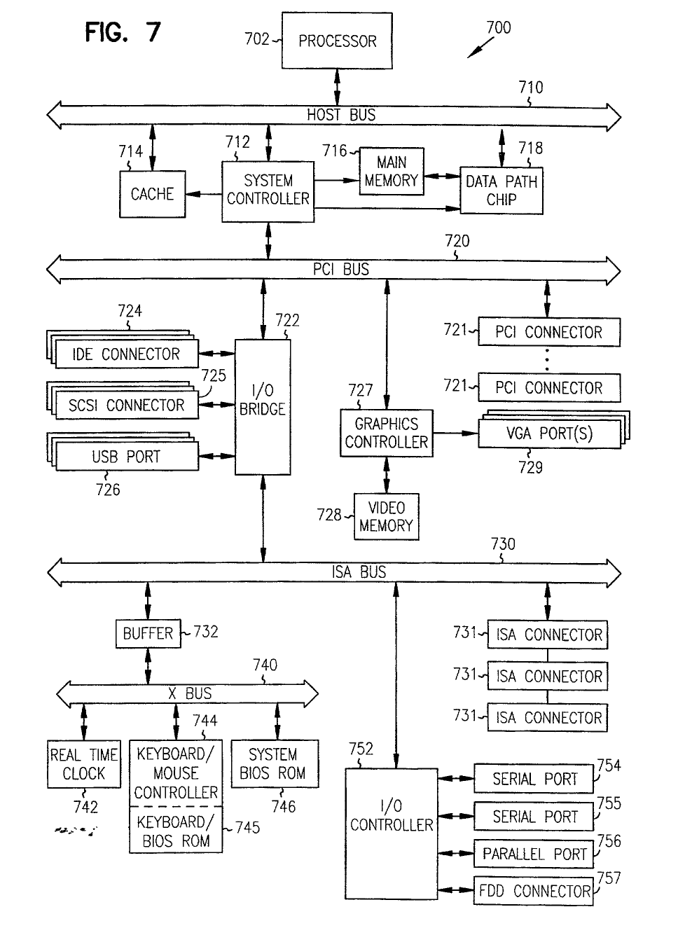

FIG. 7 is a block diagram of a computer system 700 that generates a personalized setup poster for a customer having multiple devices to assemble and/or attach to a network. Many devices to be attached to the network have similar if not identical architectures.

Computer system 700 comprises a processor 702, a system controller 712, a cache 714, and a data-path chip 718, each coupled to a host bus 710. Processor 702 is a microprocessor such as a 486-type chip, a Pentium®, Pentium® II, Pentium® III, Pentium® 4, or other suitable microprocessor. Cache 714 provides high-speed local-memory data (in one embodiment, for example, 512 kB of data) for processor 702, and is controlled by system controller 712, which loads cache 714 with data that is expected to be used soon after the data is placed in cache 712 (i.e., in the near future). Main memory 716 is coupled between system controller 714 and data-path chip 718, and in one embodiment, provides random-access memory of between 16 MB and 256 MB or more of data. In one embodiment, main memory 716 is provided on SIMMs (Single In-line Memory Modules), while in another embodiment, main memory 716 is provided on DIMMs (Dual In-line Memory Modules), each of which plugs into suitable sockets provided on a motherboard holding many of the other components shown in FIG. 7. Main memory 716 includes standard DRAM (Dynamic Random-Access Memory), EDO (Extended Data Out) DRAM, SDRAM (Synchronous DRAM), or other suitable memory technology. System controller 712 controls PCI (Peripheral Component Interconnect) bus 720, a local bus for system 700 that provides a high-speed data path between processor 702 and various peripheral devices, such as graphics devices, storage drives, network cabling, etc. Data-path chip 718 is also controlled by system controller 712 to assist in routing data between main memory 716, host bus 710, and PCI bus 720.

In one embodiment, PCI bus 720 provides a 32-bit-wide data path that runs at 33 MHz. In another embodiment, PCI bus 720 provides a 64-bit-wide data path that runs at 33 MHz. In yet other embodiments, PCI bus 720 provides 32-bit-wide or 64-bit-wide data paths that run at higher speeds. In one embodiment, PCI bus 720 provides connectivity to I/O bridge 722, graphics controller 727, and one or more PCI connectors 721 (i.e., sockets into which a card edge may be inserted), each of which accepts a standard PCI card. In one embodiment, I/O bridge 722 and graphics controller 727 are each integrated on the motherboard along with system controller 712, in order to avoid a board-connector-board signal-crossing interface and thus provide better speed and reliability. In the embodiment shown, graphics controller 727 is coupled to a video memory 728 (that includes memory such as DRAM, EDO DRAM, SDRAM, or VRAM (Video Random-Access Memory)), and drives VGA (Video Graphics Adaptor) port 729. VGA port 729 can connect to industry-standard monitors such as VGA-type, SVGA (Super VGA)-type, XGA-type (extended Graphics Adaptor) or SXGA-type (Super XGA) display devices. Other input/output (I/O) cards having a PCI interface can be plugged into PCI connectors 721. Network connections providing video input are also represented by PCI connectors 721, and include Ethernet devices and cable modems for coupling to a high speed Ethernet network or cable network which is further coupled to the Internet.

In one embodiment, I/O bridge 722 is a chip that provides connection and control to one or more independent IDE or SCSI connectors 724-725, to a USB (Universal Serial Bus) port 726, and to ISA (Industry Standard Architecture) bus 730. In this embodiment, IDE connector 724 provides connectivity for up to two standard IDE-type devices such as hard disk drives, CDROM (Compact Disk-Read-Only Memory) drives, DVD (Digital Video Disk) drives, videocassette recorders, or TBU (Tape-Backup Unit) devices. In one similar embodiment, two IDE connectors 724 are provided, and each provide the EIDE (Enhanced IDE) architecture. In the embodiment shown, SCSI (Small Computer System Interface) connector 725 provides connectivity for up to seven or fifteen SCSI-type devices (depending on the version of SCSI supported by the embodiment). In one embodiment, I/O bridge 722 provides ISA bus 730 having one or more ISA connectors 731 (in one embodiment, three connectors are provided). In one embodiment, ISA bus 730 is coupled to I/O controller 752, which in turn provides connections to two serial ports 754 and 755, parallel port 756, and FDD (Floppy-Disk Drive) connector 757. At least one serial port is coupled to a modem for connection to a telephone system providing Internet access through an Internet service provider. In one embodiment, ISA bus 730 is connected to buffer 732, which is connected to X bus 740, which provides connections to real-time clock 742, keyboard/mouse controller 744 and keyboard BIOS ROM (Basic Input/Output System Read-Only Memory) 745, and to system BIOS ROM 746.

The integrated system performs several functions identified in the flowchart of FIGS. 1 and 2. Such functions are implemented in software in one embodiment, where the software comprises computer executable instructions stored on computer readable media such as disk drives coupled to connectors 724 or 725, and executed from main memory 716 and cache 714. The term “computer readable medium” is also used to represent carrier waves on which the software is transmitted.

### CONCLUSION

While several embodiments of the invention have been described, other embodiments may also be used with departing from the scope of the invention. Printed posters are just one form of output for the method of providing instructions for setup of multiple devices in a network configuration. The present invention provides a customized map for assembling a network of devices. With the advent of additional networked devices, and the lack of experience of most users in putting together a network of devices, the customized posters, including instructions, make it easier for a user to configure more complex and varied networks of devices. It is manifestly intended that this invention be limited only by the claims and equivalents thereof.

What is claimed is:

1. A computer implemented method of generating installation instructions for multiple devices to be configured in a network environment, the method comprising:
obtaining information regarding devices to be coupled by a network;
creating customized instructions for setting up the devices; and
generating graphical representations of the devices as part of the instructions indicating an order for setting up the devices.

2. The method of claim 1 wherein the information is obtained via an interactive session at a point of sale computer system.

3. The method of claim 2 wherein the interactive session involves a customer answering questions about the devices to be coupled by a network.

4. The method of claim 3 wherein the devices are selected from a group consisting of computers, wireless network adapters, printers, photo printers, scanners, fax machines, digital cameras, video cameras and storage devices.

5. The method of claim 1 wherein the graphical representations of the devices comprise images of the devices.

6. The method of claim 5 wherein the instructions comprise a poster depicting the devices and their connections.

7. The method of claim 6 wherein the order of installation is specified for each device on the poster.

8. The method of claim 6 and further comprising providing personalized information on the poster.

9. The method of claim 6 and further comprising generating a further illustration depicting set up of one of the devices.

10. A computer readable medium having instructions for causing a computer to perform a method of generating installation instructions for multiple devices to be configured in a network environment, the method comprising:
obtaining information regarding devices to be coupled by a network;
creating customized instructions for setting up the devices; and
generating graphical representations of the devices as part of the instructions indicating an order for setting up the devices.

11. The computer readable medium of claim 10 wherein the graphical representations of the devices comprise images of the devices.

12. The computer readable medium of claim 10 wherein the instructions comprise a poster depicting the devices and their connections.

13. The computer readable medium of claim 12 wherein the order of installation is specified for each device on the poster.

14. A computer implemented method of generating installation instructions for multiple devices to be configured in a network environment, the method comprising:
querying a user to obtain information regarding devices to be coupled by a network;
querying a database to obtain further information regarding customization of the network;
creating instructions for setting up the devices; and
generating graphical representations of the devices as part of the instructions indicating an order for setting up the devices.

15. The method of claim 14 wherein information is obtained via an interactive session at a point of sale computer system.

16. The method of claim 15 wherein the interactive session involves a customer answering questions about the devices to be coupled by a network.

17. The method of claim 16 wherein the devices are selected from a group consisting of computers, wireless network adapters, printers, photo printers, scanners, fax machines, digital cameras, video cameras and storage devices.

18. The method of claim 14 wherein the graphical representations of the devices comprise images of the devices.

19. The method of claim 18 wherein the instructions comprise a poster depicting the devices and their connections.

20. The method of claim 19 wherein the order of installation is specified for each device on the poster.

21. The method of claim 19 and further comprising providing personalized information on the poster.

22. The method of claim 19 and further comprising generating a further illustration depicting set up of one of the devices.

23. A method of creating a personalized poster that provides instructions for installing a plurality of connected devices, the method comprising:
interactively entering data on a graphical user interface specifying the devices to be connected; and
generating a personalized poster based on the entered data.

24. A system for generating installation instructions, the system comprising:
a computer that obtains information from a customer regarding devices to be coupled by a network;
the computer creating customized instructions for setting up the devices; and
an output device that generates graphical representations of the devices as part of the instructions indicating an order for setting up the devices.

25. The system of claim 24 wherein the computer comprises a point of sale computer system providing an interactive session with the customer.

26. The system of claim 24 and further comprising a printer that prints the instructions comprising images of the devices.

27. The system of claim 26 wherein the instructions comprise a poster depicting the devices and their connections.

28. The system of claim 27 wherein the order of installation is specified for each device on the poster.

29. The system of claim 27 and further comprising personalized information printed on the poster.

30. A system for generating installation instructions, the system comprising:
a computer that obtains information from a customer and a database regarding devices to be coupled by a network;
the computer creating customized instructions for setting up the devices; and
an output device that generates graphical representations of the devices as part of the instructions indicating an order for setting up the devices.14.
querying a user to obtain information regarding devices to be coupled by a network;

31. A computer readable medium having a network topology file comprising:
customer contact information;
identifications of devices currently possessed by the customer;
identifications of devices being purchased by the customer;
pictures of the devices to be connected to a network; and
information specifying the order in which devices are to be set up.

32. The computer readable medium of claim 31 and further comprising network identifications for the devices.

33. The computer readable medium of claim 31 and further comprising setup chunks with screen shots of wizard screens for use in setting up the devices on the network.

34. The computer readable medium of claim 31 and further comprising information regarding the expected use of the network by the customer.

35. A method of setting up a network of devices, the method comprising:
obtaining a personalized poster illustrating the order of connection of devices to be set up;
setting up the devices in accordance with the poster; and
using personalized information on the poster to interact with setup software wizards.

36. A method of selling computers to be configured with other devices in a network environment, the method comprising:
obtaining user specific information regarding devices to be coupled by a network;
creating customized instructions for setting up the devices; and
generating graphical representations of the devices as part of the instructions indicating an order for setting up the devices.
